(19) United States
(12) Patent Application Publication
(10) Pub. No.: US 2007/0268823 A1
(43) Pub. Date: Nov. 22, 2007

(54) Device and method for managing oversubscription in a network

(76) Inventors: Ken Madison, Santa Clara, CA (US); Poly Palamuttam, San Jose, CA (US); Ravinder Sajwan, Saratoga, CA (US); Mathew Steinberg, Livermore, CA (US); Marek Thalka, Fremont, CA (US)

Correspondence Address: FOOTHILL LAW GROUP, 777 N. FIRST STREET, SUITE 325, SAN JOSE, CA, 95112, US

(21) Appl. No.: 11/643,339

(22) Filed: Dec. 20, 2006

Related U.S. Application Data
(63) Continuation-in-part of application No. 10/930,267, filed on Aug. 30, 2004.

(51) Int. Cl. G08C 15/00

(52) U.S. Cl. 370/229

(57) ABSTRACT

A device and a method for aggregating and managing large quantities of data are disclosed. The received data are prioritized into high and low priority queues. The device receive memory is partitioned into blocks which are further divided into free list and allocation list. The low priority queues occupy between 1 and 48 blocks and the high priority queues occupy between 1 and 32 blocks. The incoming data are further subjected to Weighted Random Early Detection (WRED) process that controls congestion before it occurs by dropping some of the queues. The stored data are read using Modified Deficit Round Robin (MDRR) approach. The invention further employees several different filtering approaches for prioritizing data.

This application claims priority of filing date of U.S. application Ser. No. 10/930,267, the contents of which are herein incorporated by reference in the entirety.

### FIELD OF THE INVENTION

The invention relates to the field of data transmission from multiple sources and more specifically to managing data when an Ethernet network is oversubscribed.

### BACKGROUND OF THE INVENTION

It is quite common to have a data network operate at less than its full capacity, typically around 50% utilization. This is due primarily to the “bursty” nature of the data being transmitted. This is quite costly and methods have been developed to better utilize the available capacity. One approach oversubscribes the system by some factor and exploits the fact that many users will not be utilizing the system all at the same time, thus having sufficient capacity available under most conditions. This approach allows the designer to play the “averages” by assigning the information processing rate to a port that is greater than the speed of the port. The approach is attractive as it saves the costs of the port connections, typically a significant portion of the total system cost. However, to successfully implement such approach, one requires historic information about the network usage, such as that obtained from actual system measurements.

Oversubscription has been successfully tried in WAN networks, voice transmission such as PBX networks, ATM equipment, etc. Similarly, in the Ethernet data transmission, it can be expected that different users will require higher rate of utilization at different times, thus creating an opportunity to employ oversubscription, improve the system utilization and reduce the overall costs. For this approach to succeed, it must not sacrifice the quality of service the end user expects, and therefore, must avoid congestion, minimize packet drops and provide proper handling of high priority traffic. The device of this invention meets such requirements.

### SUMMARY OF THE INVENTION

An embodiment of the present invention aggregates large quantity of data and manages an oversubscribed data transmission system. The data enters the device from an 8 port Physical Layer (PHY) by the way of a Reduced Medium Independent Interface (RMII) or Reduced Gigabit Medium Independent Interface (RGMII) through a Media Access Control (MAC) device. Up to three 8 port PHY devices may be used. The incoming data are then classified into high and low priority according to the priority level contained in their virtual Local Area Network (vLAN) tag. The prioritized data are then processed through Weighted Random Early Detection (WRED) routine. The WRED routine prevents congestion before it occurs by dropping some data and passing other according to the pre-determined criteria. The passed data are written into the memory that is divided into 480 1 Kbyte (KB) buffers (blocks). The buffers are further classified into a free list and an allocation list. The data are written into the memory by the Receive Write Memory manager. Each port on the device of this invention accommodates a high priority queue and a low priority queue, with low priority queue being allocated up to 48 blocks and the high priority queue up to 32 blocks. The stored data are read by the Receive Read Memory Manager, with each port being serviced in round robin fashion, and within a port, high and low priority queues are serviced by using Modified Deficit Round Robin (MDRR) approach. The data are then transmitted out of the device via an SPI 4.2 or similar approach.

In this application, the terms data, frame, packet are used interchangeably

### OBJECTS AND ADVANTAGES

One object of the present invention is to use a code to prioritize the data traffic.

Another object of the invention is to selectively drop a portion of the data traffic.

Still another object of the present invention is to selectively drop a portion of data traffic.

Yet another object of the present invention is to employ virtual Local Area Network (vLAN), inner vLAN, outer vLAN, Destination Address, Source Address, multicast destination address, Layer 2 Ethertype, LLC/SNAP encoding, IP protocol, IP version protocol, DCCP and Layer 3 protocol labels to prioritize data traffic.

One object of the present invention to drop traffic by employing Weighted Random Early Detection approach.

Still another object of the present invention is to partition memory resources into distinct blocks.

Yet another object of the present invention is to partition memory resources into a free list and an allocation list.

### BRIEF DESCRIPTION OF THE DRAWINGS

FIG. 1 shows the OSI reference model.

FIG. 2 is the block diagram of the invention.

FIG. 3 is the overall process flow chart.

FIG. 4 is Ethernet frame format with vLAN tag.

FIG. 4B shows the round-robin approach to enqueueing.

FIG. 5 is vLAN priority to queue mapping table.

FIG. 6 shows the WRED drop probability graph.

FIG. 7 is the frame drop behavior table.

FIG. 8 shows the MDRR approach.

### DETAILED DESCRIPTION

### Overview

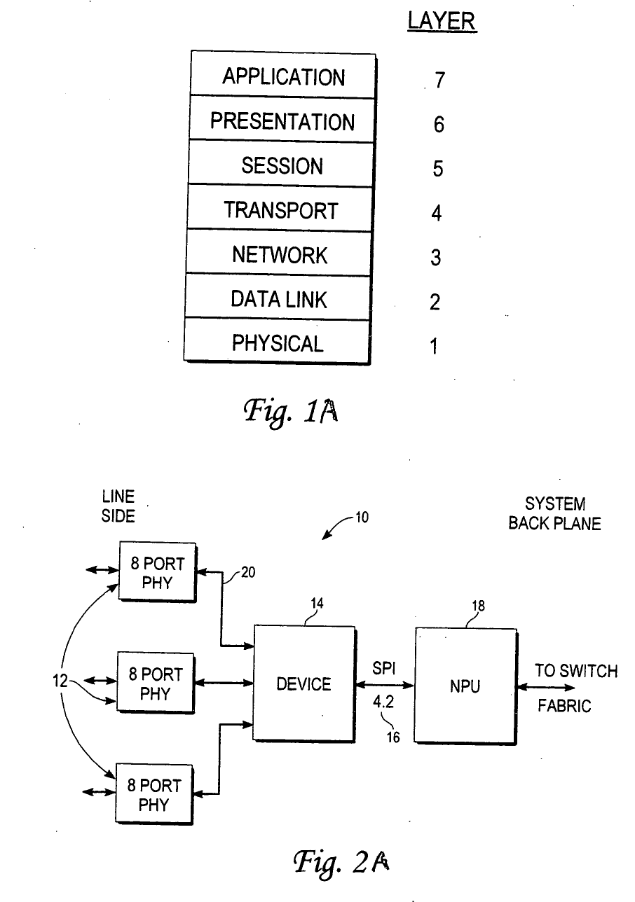

Many different types of hardware and software from a broad base of vendors are continually entering the communications market. In order to enable communications between such devices a set of standards has been developed. Shown in FIG. 1 is an International Standards Organization (ISO) reference model for standardizing communications systems called the Open Systems Interconnect (OSI) Reference Model. The OSI architecture defines the communications process as a set of seven layers, with specific functions isolated and associated with each layer. The layer isolation permits the characteristics of a given layer to change without impacting the other layers, provided that the supporting services remain the same. Each layer consists of a set of functions designed to provide a defined series of services.

Layer 1, the physical layer (PHY), is a set of rules that specifies the electrical and physical connections between devices. This level specifies the cable connections and the electrical rules necessary to transfer data between devices. It typically takes a data stream from an Ethernet Media Access Controller (MAC) and transforms it into electrical or optical signals for transmission across a specified physical medium. PHY governs the attachment of the data terminal equipment, such as serial port of personal computers, to data communications equipment, such as modems.

Layer 2, the data link layer, denotes how a device gains access to the medium specified in the physical layer. It defines data formats, including the framing of data within transmitted messages, error control procedures, and other link control activites. Since it defines data formats, including procedures to correct transmission errors, this layer becomes responsible for reliable delivery of information.

Layer 3, the network layer, is responsible for arranging a logical connection between the source and the destination nodes on the network. This includes the selection and management of a route for the flow of information between source and destination, based on the available data paths in the networks.

Layer 4, the transport layer, assures that the transfer of information occurs correctly after a route has been established through the network by the network level protocol.

Layer 5, the session layer provides a set of rules for establishing and terminating data stream between nodes in a network. These include establishing and terminating node connections, message flow control, dialogue control, and end-to-end data control.

Layer 6, the presentation layer, addresses the data transformation, formatting, and syntax. One of its primary functions of this layer is the conversion of transmitted data into a display format appropriate for a receiving device.

Layer 7, the application layer, acts as a window through which the application gains access to all the services provided by the model. This layer typically performs such functions as file transfers, resource sharing and database access.

As the data flows within a network, each layer appends appropriate heading information to frames of information flowing within the network, while removing the heading information added by the proceeding layer.

Shown in FIG. 2 is the over-all basic block diagram 10 of the interaction of the typical embodiment of the device of this invention 14 and other communications components. The data enters form the line side via a PHY 12 device (ingress) and may flow bi-directionally. In this case PHY 12 is an 8 Port device capable of operating at 10 Mega bits per second (Mbps), 100 Mbps or 1 Giga bit per second (Gbps) for each port, resulting in a total of 24 Gbps for 24 ports. The information from the PHY 12 is transmitted to the device 14 via interface 20, typically Reduced Medium-Independent Interface (RMII) or Reduced Gigabit Medium-Independent Interface (RGMII). The device 14 aggregates the information from all 24 ports and transmits it to Network Processor Unit (NPU) 18 via System Packet Interface Level 4 Phase 2 (SPI 4.2) or a device of similar capability. Depending on the operating speed of SPI 4.2 or a device of similar capability and a particular RGMII mode used, e.g. 1 Gigabits/sec, the device 14 may be oversubscribed by a ratio of up to 8:1 on the line side. The data is then directed from NPU 18 to suitable switch fabric on the system back-plane.

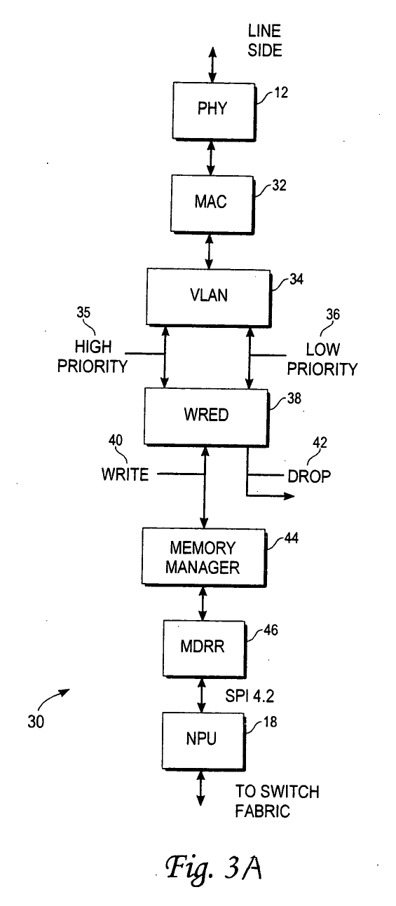

Shown in FIG. 3 is the general process flow chart applicable to each port for the data being transmitted between the PHY 12 and the switch fabric. The data enters the device 14 via a generally available Media Access Control Device (MAC) 32. The MAC 32 may be integrated with the device 14 or it may be a separate unit. In general terms MAC 32 or a similar device is employed to control the access when there is a possibility that two or more devices may want to use a common communication channel. In this embodiment device 14 employs up to 24 MACs 32.

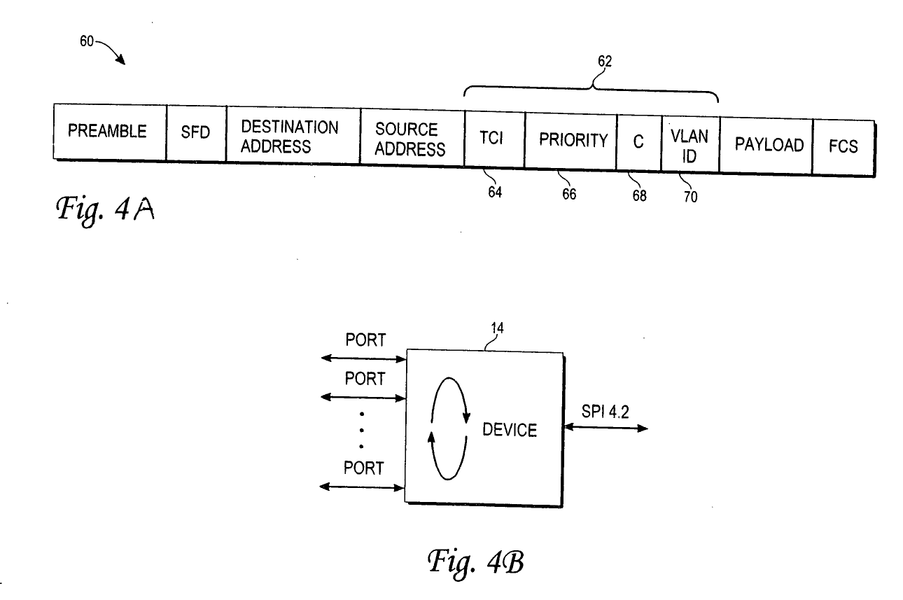

The Ethernet data stream is typically transmitted to the ingress side of device 14 in Ethernet frame format 60 with a virtual Local Area Network (vLAN) tag 62 shown in FIG. 4. The Ethernet frame 60 conforms with IEEE 802.1Q frame format. The primary purpose of the vLAN tag 62 is to determine the priority of the incoming data traffic based on Class of Service (CoS) and classify it accordingly. The components of the vLAN tag 62 are: Tag Control Identifier (TCI) 64, Priority filed 66 (typically 3 bits of data per IEEE 802.1p standard), Canonical Format Identifier 68 and vLAN identity information 70 (typically 12 bits of data). Generally, the vLAN 62 makes it appear that a set of stations and applications are connected to a single physical LAN when in fact they are actually not. The receiving station can determine the type of the frame and correctly interpret the data carried in the frame. One with skill in the art would be able to program the type of routine needed to retrieve this information. To properly identify the type of the frame received, the value of the bits following the source address is examined. If the value is greater than 1500, an Ethernet frame is indicated. If the value is 8100, then the frame is IEEE 802.1Q tagged frame and the software would look further into the tag to determine vLAN identification and other information.

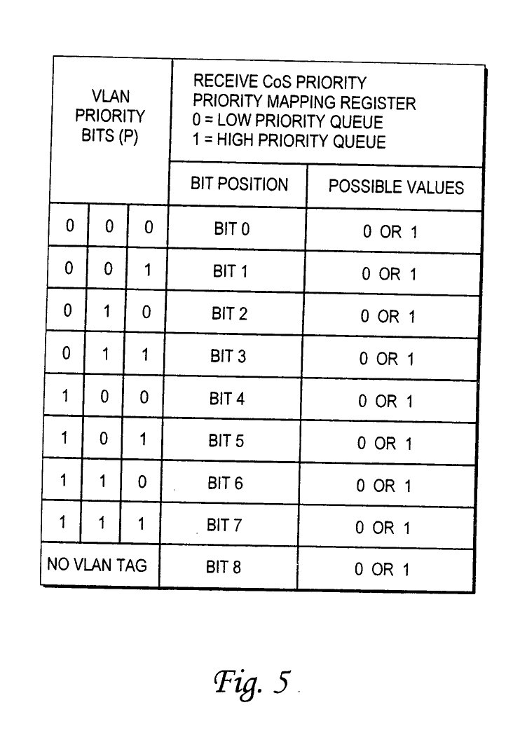

All ingress ports are scanned in round robin fashion resulting in an equitable process for selecting ports for enqueueing, i.e. for entering the device 14. This is shown in FIG. 4B. Multiple priority queues are associated with each port. Some queues are used for high priority traffic and some for low priority traffic. The over-subscription logic of device 14 obtains priority designation from the vLAN priority field 66 of the vLAN tag 62. The 3-bit vLAN priority field 66 indexes into a user programmable table that provides the lookup needed to determine the priority level. Typically, the upper four of the eight priority levels are mapped into a high priority queue and the lower four priority levels are mapped into low priority queue. If there is no VLAN 62 tag, all levels default to a single queue. FIG. 5 shows vLAN priority field 66 mapping table and the Class of Service (CoS) priority mapping register.

The device 14 also employs an IEEE 802.3-2000 compliant flow control mechanism. Each RGMII port with its MAC will perform independent flow control processing. The basic mechanism uses the PAUSE frames per the 802.3x specification. Each of the high and low priority queues associated with each port is programmed with a desired threshold value. When this value is exceeded, a PAUSE frame is generated and sent to a remote upstream node. The device 14 provides two different options for the PAUSE frame. In the first option, a 16-bit programmable timer value is sent in the PAUSE frame, this bit being used by the receiver as a pause quantum. No further PAUSE frames are sent. When the quantum expires, the transmission begins again. In the second option, the MAC sends a PAUSE frame when the threshold is exceeded and another PAUSE frame with a zero pause quanta when the buffers go below threshold signifying that the port is ready to receive data again.

An additional feature of the device of this invention found in the Layer 2 (Data Link Layer) is Weighted Random Early Detection (WRED) 38 (see FIG. 3) scheme, presently available in the art. Here, WRED is employed to limit the incoming data rate to avoid congestion by dropping some of the data packets per a predetermined criteria. In this scheme, frames are dropped with some probability if certain threshold is exceeded. Anticipating congestion and dropping frames early in this manner, congestion due to bursty traffic can be avoided.

Generally, Random Early Detection (RED) aims to control the average queue size by indicating to the end hosts when they should temporarily slow down transmission of packets. RED takes advantage of the congestion control mechanism of Transmission Control Protocol (TCP). By randomly dropping packets prior to periods of high congestion, RED communicates to the packet source to decrease its transmission rate. Assuming the packet source is using TCP, it will decrease its transmission rate until all the packets reach their destination, indicating that the congestion is cleared. Additionally, TCP not only pauses, but it also restarts quickly and adapts its transmission rate to the rate that the network can support. RED distributes losses in time and maintains normally low queue depth while absorbing spikes. When enabled on an interface, RED begins dropping packets when congestion occurs at a pre-selected rate.

### Packet Drop Probability

The packet drop probability is based on the minimum threshold, maximum threshold, and mark probability denominator. When the average queue depth is above the minimum threshold, RED starts dropping packets. The rate of packet drop increases linearly as the average queue size increases until the average queue size reaches the maximum threshold. The mark probability denominator is the fraction of packets dropped when the average queue depth is at the maximum threshold. For example, if the denominator is 256, one out of every 256 packets is dropped when the average queue is at the maximum threshold. When the average queue size is above the maximum threshold, all packets are dropped.

The minimum threshold value should be set high enough to maximize the link utilization. If the minimum threshold is too low, packets may be dropped unnecessarily, and the transmission link will not be fully used. If the difference between the maximum and minimum thresholds is too small, many packets may be dropped at once.

WRED 38 combines the capabilities of the RED algorithm with the Internet Protocol (IP) precedence feature to provide for preferential traffic handling of higher priority packets. WRED 38 can selectively discard lower priority traffic when the interface begins to get congested and provide differentiated performance characteristics for different classes of service. WRED 38 can also be configured to ignore IP precedence when making drop decisions so that non-weighted RED behavior is achieved.

WRED 38 differs from other congestion avoidance techniques such as queueing strategies because it attempts to anticipate and avoid congestion rather than control congestion once it occurs. WRED 38 makes early detection of congestion possible and provides for multiple classes of traffic.

By dropping packets prior to periods of high congestion, WRED 38 communicates to the packet source to decrease its transmission rate. If the packet source is using TCP, it will decrease its transmission rate until all the packets reach their destination, which indicates that the congestion is cleared.

### Average Queue Size

The average queue size is based on the previous average and the current size of the queue. The formula is:
average=(old average*(1−2⁻ⁿ))+(current queue size*2⁻ⁿ)
where n is the exponential weight factor, a user-configurable value. For high values of n, the previous average becomes more important. A large factor smooths out the peaks and lows in queue length. The average queue size is unlikely to change very quickly, avoiding drastic swings in size. The WRED 38 process will be slow to start dropping packets, but it may continue dropping packets for a time after the actual queue size has fallen below the minimum threshold (Kbytes). The slow-moving average will accommodate temporary bursts in traffic. For low values of n, the average queue size closely tracks the current queue size. The resulting average may fluctuate with changes in the traffic levels. In this case, the WRED 38 process responds quickly to long queues. Once the queue falls below the minimum threshold, the process will stop dropping packets. If the value of n gets too low, WRED 38 will overreact to temporary traffic bursts and drop traffic unnecessarily. If the average is less than the minimum queue threshold, the arriving packet is queued. If the average is between the minimum queue threshold and the maximum queue threshold, the packet is either dropped or queued, depending on the packet drop probability. If the average queue size is greater than the maximum queue threshold, the packet is automatically dropped.

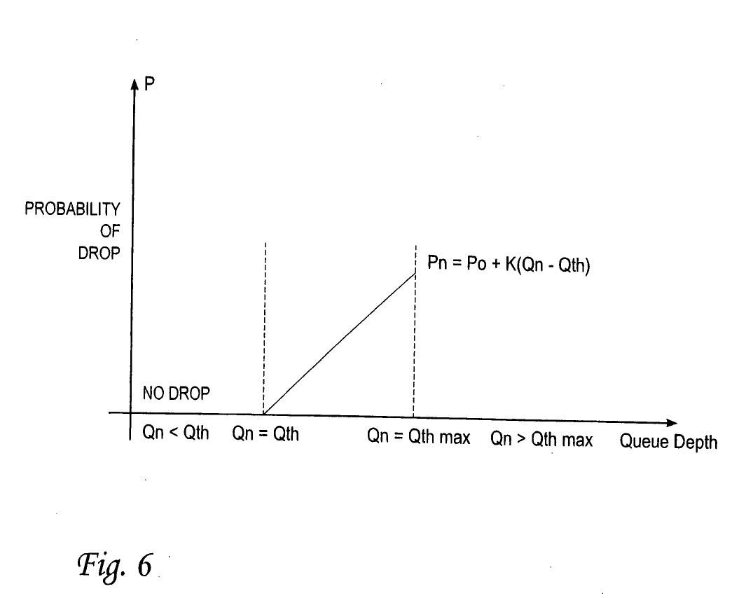

Specifically, WRED 38 provides up to four programmable thresholds (watermarks) associated with each of the two queues. Corresponding to four thresholds, four programmable probability levels are provided creating four threshold-probability pairs. This relationship is shown in FIG. 6, where Probability of Drop is given by the following expression:
Pₙ=P₀+K(Q_{wn}−Qₜₕ)
Pₙ=the new calculated probability
Pₒ=user programmable initial probability
Qₜₕ=the initial threshold level of the queue
Q_{wn}=the n level watermark
K=constant

The threshold is the value on queue level (queue depth) and the corresponding probability is the probability of dropping a frame if the corresponding threshold is exceeded. It is also possible to set thresholds on some ports to guarantee no frame drops. This option is possible for only a subset of ports operating in the 1 Gbps mode.

The value of constant K determines how big the probability of drop is for a given queue filling over the threshold Qₜₕ. One skilled in the art will be able to determine proper level of K for the specific application. The device 14 supports four programmable watermarks per queue and based on each level, Pₙ, the probability for drop is calculated for the next sequence. The frames which are not dropped are written into the device 14 memory, such memory being either internal or external to the device 14. The threshold for low and high priority queues are programmed in the device 14 registers. Here, the device 14 utilizes CfgRegRxPauseWredLpThr and CfgRegRxPauseWredHpThr registers. Associated probabilities are programmed into registers: CfgRegRxWredLpProb and CfgRegRxPauseWredHpThr. A person skilled in the art will be able to properly define such registers.

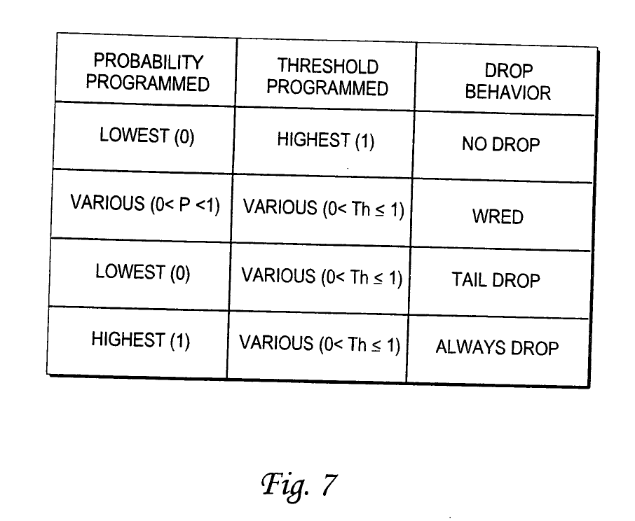

FIG. 7 shows combination of probability and threshold levels used and the corresponding frame drop behavior.

### Enqueueing Operation

Generally, frames enter from the RGMII interface into the MAC 32 receive side and are subjected to vLAN and WRED tests described above before writing into the receive memory located in the receive memory manager 44. Memory manager 44 is organized as a pool of preferably 1Kbyte buffers (or blocks) for a minimum of 480 blocks in case of a 24 port device 14. The 1 Kbyte buffer size enables easy memory allocation from ports that have small amount or no data arriving to them to other ports that are more occupied and need the memory. The buffers can be further classified into an allocation list and the free list. Each port has two allocation lists, one is high priority queue and the other a low priority queue. The high priority queue can occupy between 1 and 32 blocks unless there is no priority mechanism and all packets fall into one queue. The low priority queue can occupy between 1 and 48 blocks. The size of the low priority queue is larger than the high priority queue because the high priority queue is serviced more frequently. The buffers are reserved as soon as the data transmission starts, i.e., as soon as VLAN tag has been read and the data is classified as high or low priority queue. The unoccupied buffers are kept in a free list and signify the amount of memory remaining after the total of 480 Kbytes have been decremented by the allocation list.

The receive memory operates at a frequency of 140 MHz making a total of 36 Gbps of bandwidth for writing and reading the data. The memory may be a dual ported RAM or a device with similar capabilities. This memory is sufficient to handle the case of all 24 ports running at 1 Gbps and SPI 4.2 running at full speed.

The data are written into the memory manager by Receive Write Memory Manager (RxWrMemMgr) that generally functions as follows:
Operates at 155 MHz system clock frequency.
Reads 32 bytes from each port in a round robin fashion.
Retrieves free buffers for the requesting ports from the free list.
Uses the priority information in the start of packet (SOP) inband control word to write into memory buffer.
Forms the address to write data read from the RxMacFifo (receive MAC, first in first out) into the memory by appending the pointer to memory buffer from the allocation list and the curr (current)_wr_ptr_curr_wr_offset incremented after every write.
Increments EOP (end of packet) counter associated with each queue after writing in the last byte (ErrorNalid EOP).
Uses the drop registers to decide on packet drops. When a number of buffers used per queue exceeds certain threshold, packets are dropped with fixed probability. The threshold and the probability are programmed in the four WRED registers associated with each queue. Drop is achieved by reading packets from the RxMacFifo but not writing them into the memory.

RxWrMemMgr employes the following basic data structure:
A 480 entry buffer list pointing to the start of each of the 480 Kbyte buffers (rx_free_list).
High (up to 32 entries) and low (up to 48 entries) allocation lists per port (rx_port_qh and rx_port_ql).
A current write offset into the current active buffer for each que (rx_curr_wr_offset).
A current read offset into the current active buffer for each queue (rx_curr_rd_offset).
A write pointer pointing to written buffers for the entry allocation list (rx_port_buffers_wrt_ptr).
A read pointer pointing to read buffers for the entry list (rx_port_buffers_rd_ptr).
A set of four Drop registers per port for setting thresholds for the WRED-like function. The registers contain threshold for the number of buffers used by the port and the probability associated with dropping a packet for that particular threshold.
An EOP (end of packet) counter associated with each queue that is incremented whenever a complete packet is written into the memory.
Functions:

A pop function that looks at the address of free buffer(s), free_list, sends that information to the requesting port and returns a pointer to a free buffer to the requesting port.

function pop 0;
{
return (ptr_to_free_buff);
}

A push function that returns the used buffer to the free_list from logic:

function push (ptr_to_used_buffer;)
{
return (status);
}

A read scheduler (arbiter—arb) that returns next port to be read from:

function next_port (input req [(0:23])
{
return (next_port_to_read);
}

### Dequeueing Operation

The Receive Read Memory Manager is responsible for de-queueing data from the 48 (24 high priority and 24 low priority) queues and it operates at 155 MHz system clock frequency. Ports are serviced in a round robin fashion, however, within a port, high and low priority queues are serviced using commercially available MDRR 46 (Modified Deficit Round Robin) based approach.

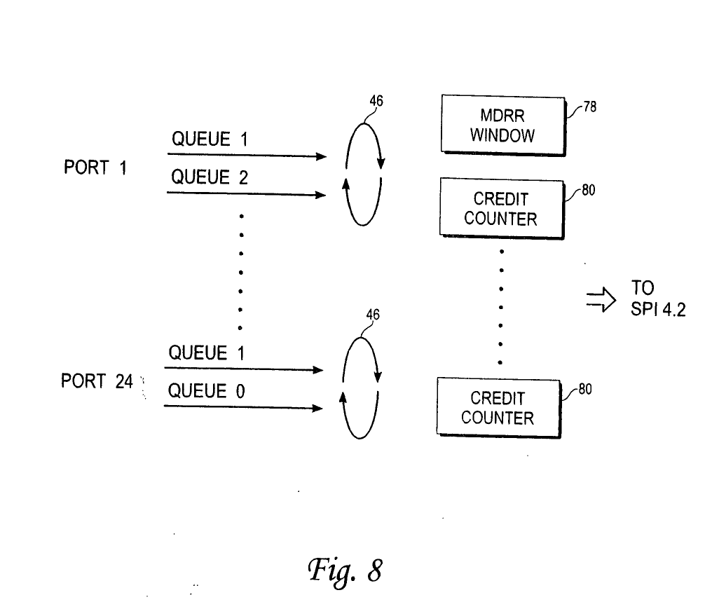

The MDRR 46 approach provides fairness among the high and low priority queues and avoids starvation of the low priority queues. Complete Ethernet frames are read out from each queue alternatively until the associated credit register reaches zero or goes negative. The MDRR 46 approach assigns queue 1 of the group as low latency, high priority (LLHP) queue for special traffic such as voice. This is the highest priority Layer 2 CoS queue. LLHP queue is always serviced first and then queue 0 serviced. A configurable credit window 78 and credit counter 80 shown in FIG. 8 are added for each high and low priority queues. The credit window 78 sets the maximum bound for dequeueing for the port. The credit counter 80 represents the number of 16-byte transfers available for the queue for the current round. The credit counter 80 is checked at the beginning of the service and if the credit count is positive, the queue is serviced. If the credit count is zero, but the queue contains at least a maximum burst 1 or maximum burst 2 bytes the queue will be serviced. Once a queue is serviced a fixed amount of programmable credits are added to the queue. The only time a queue will not be serviced is when there is no data in the queue.

The dequeued data are transmitted via SPI 4.2 to NPU 18 or a device of similar capability.

### Transmit Write Memory Manager (TxWrMemMgr)

The transmit memory is organized as a pool of 240 1 K Byte buffers. The TxWrMemMgr operates at 155 MHz and reads 32 bytes from each SPI 4.2 port in a round robin fashion, retrieves free buffers for requesting ports from the free list, forms the address to write data from the RxMacFifo into the memory by appending the pointer to memory buffer from the allocation list and the curr_wr_ptr and increments it after every write and increments EOP counter (eop_counter) associated with each port after writing in the last byte (Error/Valid EOP). The memory operates at 140 MHz and has a total bandwidth of 35 Gbits for reading and writing the data.

The TxWrMemMgr employees the following basic data structure:
A 240 entry free list buffer pointing to the start fo each of the 240 1 Kbyte buffers (tx_free_list).
One 32 entry allocation list per port (tx_port_ql).
A current write offset for pointing into the current write location in the active buffer for each queue (tx_curr_wr_offset).
A current read offset for pointing into the current read location in the active buffer for each queue (tx_curr_rd_offset).
A Write pointer pointing to written buffers for the 32 entry allocation list (tx_port_buffers_wrt_ptr).
A Read pointer pointing to the read buffers for the 32 entry list (tx_port_buffers_rd_ptr).
An EOP counter (eop_counter) associated with each queue that is incremented whenever a complete packet is written into the memory.
   Functions:

A pop function that pops a buffer form the free_list and returns a pointer to a free buffer to a requesting port.

function pop 0;
{
return (ptr_to_free_buff);
}

A push function that returns used buffers to the free_list from logic.

Function push (ptr_to_used_buffer);
{
return (status):
}

In another embodiment the device of this invention employs Multi Protocol Label Switching (MPLS) filtering. When MPLS filtering is enabled, all MPLS-formatted frames will have their permit/deny and CoS assignment made in the MPLS filter. This is due to the fact that some MPLS encodings makes further frame decode impossible, because the number of MPLS labels and their contents cannot be unambiguously determined when Ethernet-encapsulated.

TABLE A
Typical MPLS Encapsulation

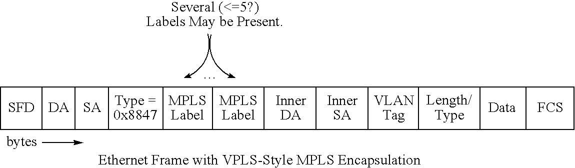

The MPLS utilizes two different types of MPLS-based forwarded mechanisms. They are known as E-LSP and L-LSP. E-LSPs, which are EXP-Inferred Per Hop Behavior Scheduling Class Label Switch Paths, use the EXP field of the MPLS entry to determine the correct scheduling and drop precedence. L-LSPs, which are Label-Only-Inferred Per Hop Behavior Scheduling Class Label Switch Paths, use the MPLS label to explicitly establish the Forwarding Equivalency Class (FEC) and the Ordered Aggregate (OA) behavior.

TABLE B
Alternate MPLS Encapsulation

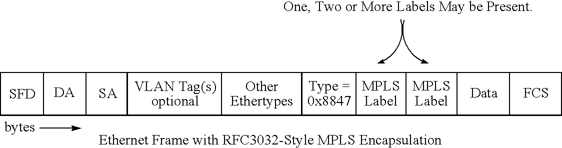

MPLS-based network elements may make use of the EXP field of the label entry or may use the label itself to establish the scheduling and drop precedence appropriate for the labeled packet. Either the EXP bits or the outer label are used or a direct CoS assignment is made.

Examples of Ethernet frames with MPLS labels are shown in Table A and Table B, The fields of an MPLS label are shown in Table C.

TABLE C
MPLS Fields

| | | | |
|---|---|---|---|
| Label (20 bits) | Exp | S | TTL (8 bits) |

The device will classify frames containing MPLS labels. The MPLS classification takes places on the device's port-wide basis.

If MPLS classification is enabled, the device will use the contents of the four MPLS Type Field Match Registers to determine which Ethernet frames contain the desired packets. The control fields of the MPLS Type Field Match Registers are shown in Table D. For E-LSP MPLS implementations, the CoS control functionality shown in Table D is sufficient to properly assign the CoS. For L-LSPs, the CoS mechanism described in Tables F, G and H is used.

TABLE D
MPLS Type Field Match Register (x4)

| Field | Function | Comments |
|---|---|---|
| Enable | Disables functionality when 0 | |
| Discard | When set frames with this | Defaults to 0 |
| | ethertype are discarded | |
| EtherType | The contents of the EtherType | Register 0 defaults |
| | field being matched | to 0x8847, register |
| | | 1 to 0x8848 |
| CoS Type | Determines CoS assignment | Used to enable E- |
| | method. A two-bit field: | LSP and/or L-LSP |
| | 0 -> Use CoS level C | MPLS filtering |
| | 1 -> Use priority mapping | |
| | table C to map EXP bits | |
| | 2 -> Use MPLS label match | |
| | mechanism | |
| | 3 -> Reserved | |
| C | CoS Assignment: Either the | |
| | direct CoS value or a pointer to | |
| | one of the ingress priority | |
| | mapping sets. | |
| Timestamp | If 1 then matching frames will | |
| Enable | have timestamp fields updated in | |
| | the forwarding headers. If excess | |
| | latency detect is enabled, this | |
| | may also cause the frame to be | |
| | discarded if the queuing latency | |
| | threshold is exceeded. | |
| Timestamp | Selects which timestamp delay | Voice ≦10 ms, |
| Select | will be enforced. | video ≦100 ms |

If none of the MPLS Type Fields match, control will pass to the Default MPLS Control Register, as described in Table E.

TABLE 1
Default MPLS Control Register

| Field | Function | Comments |
|---|---|---|
| Enable | Disables functionality when 0 | |
| Discard | When set frames with this | Defaults to 0 |
| | ethertype are discarded | |
| CoS Type | Determines CoS assignment | |
| | method. A two-bit field: | |
| | 0 -> Use CoS level C | |
| | 1 -> Reserved | |
| | 2 -> Reserved | |
| | 3 -> Reserved | |
| C | CoS Assignment: Either the | |
| | direct CoS value or a pointer | |
| | to one of the ingress priority | |
| | mapping sets. | |
| Timestamp | If 1 then matching frames will | |
| Enable | have timestamp fields | |
| | updated in the forwarding | |
| | headers. If excess latency | |
| | detect is enabled, this may | |
| | also cause the frame to be | |
| | discarded if the queuing | |
| | latency threshold is | |
| | exceeded. | |
| Timestamp | Selects which timestamp | Voice ≦10 ms, video |
| Select | delay will be enforced. | ≦100 ms |

The device of this invention can be used to handle traffic mixes that include MPLS-labeled and VLAN-tagged frames. Only frames that do not contain MPLS labels can be further filtered by the VLAN ID-based filtering described below. If only MPLS-labeled frames are to be permitted to ingress on this interface, the Default MPLS Control Register can be used to set the Discard eligibility bit. If this bit is set as the frame egresses the MPLS block the frame shall be discarded, even if the VLAN control tables are enabled.

### MPLS L-LSP Control

As described above, the label field of an MPLS label can be used to define a CoS. In the device, this is accomplished through the use of the MPLS L-LSP Mask, Match and Control Registers, as shown in Table F, Table G and Table H, respectively. There are eight register sets per port of the device.

TABLE F
MPLS L-LSP Mask Registers

| Register | Default Value | Comments |
|---|---|---|
| L-LSP Mask Register 0 | 0xFF FF F0 00 | Defaults to the label field |
| L-LSP Mask Register 1 | 0xFF FF F0 00 | Defaults to the label field |
| L-LSP Mask Register 2 | 0xFF FF F0 00 | Defaults to the label field |
| L-LSP Mask Register 3 | 0xFF FF F0 00 | Defaults to the label field |
| L-LSP Mask Register 4 | 0xFF FF F0 00 | Defaults to the label field |
| L-LSP Mask Register 5 | 0xFF FF F0 00 | Defaults to the label field |
| L-LSP Mask Register 6 | 0xFF FF F0 00 | Defaults to the label field |
| L-LSP Mask Register 7 | 0xFF FF F0 00 | Defaults to the label field |

TABLE G
MPLS L-LSP Match Registers
A mask register with all zeroes content disables the associated
MPLS L-LSP filter.

| | | |
|---|---|---|
| Register | Default Value | Comments |

| | |
|---|---|
| L-LSP Match Register 0 | 0x00 00 00 00 |
| L-LSP Match Register 1 | 0x00 00 10 00 |
| L-LSP Match Register 2 | 0x00 00 20 00 |
| L-LSP Match Register 3 | 0x00 00 30 00 |
| L-LSP Match Register 4 | 0x00 00 40 00 |
| L-LSP Match Register 5 | 0x00 00 50 00 |
| L-LSP Match Register 6 | 0x00 00 60 00 |
| L-LSP Match Register 7 | 0x00 00 70 00 |

If multiple entries match, the frame will be placed into the highest priority queue of those matching entries in which the Discard bit is not set. If any match control register specifies that the frame not be discarded, then it will not be discarded.

TABLE H
MPLS L-LSP Control Registers (x8)

| Field(s) | Function | Comments |
|---|---|---|
| Discard | Causes frame to be discarded | Overrides the current |
| | if set to 1 | Discard status when a |
| | | match is found. |
| CoS Type | Determines CoS assignment | |
| | method. A two-bit field: | |
| | 0 -> Use CoS level C | |
| | 1 -> Use priority mapping | |
| | table C to map EXP bits | |
| | 2 -> Reserved | |
| | 3 -> Reserved | |
| C | CoS Assignment: Either the | |
| | direct CoS value or a pointer to | |
| | one of the ingress priority | |
| | mapping sets. | |
| Programmable | The use of this bit is customer- | Defaults to 0 |
| Bit IDB | defined. | |
| Timestamp | If 1 then matching frames will | |
| Enable | have timestamp fields updated | |
| | in the forwarding headers. If | |
| | excess latency detect is | |
| | enabled, this may also cause | |
| | the frame to be discarded if the | |
| | queuing latency threshold is | |
| | exceeded. | |
| Timestamp | Selects which timestamp delay | Voice ≦10 ms, |
| Select | will be enforced. | video ≦100 ms |

The L-LSP registers function as follows:
1) The ingress MPLS label is first masked (bit-wise ANDed) with the contents of the mask registers.
2) The resulting value is then compared with the contents of the match registers.
3) If an identical value is found, then the associated control register is used to determine the resulting CoS and discard eligibility assignment for that frame.

If no match is found, then the frame will be assigned the CoS level and discard eligibility as assigned by the Default L-LSP Control Register as also shown in Table I.

TABLE I
Default L-LSP Control Register

| Field(s) | Function | Comments |
|---|---|---|
| Discard | Causes frame to be discarded | Overrides the current |
| | if set to 1 | Discard status when a |
| | | match is found. |
| CoS Type | Determines CoS assignment | |
| | method. A two-bit field: | |
| | 0 -> Use CoS level C | |
| | 1 -> Use priority mapping | |
| | table C to map EXP bits | |
| | 2 -> Reserved | |
| | 3 -> Reserved | |
| C | CoS Assignment: Either the | |
| | direct CoS value or a pointer | |
| | to one of the ingress priority | |
| | mapping sets. | |
| Programmable Bit | The use of this bit is | Defaults to 0 |
| IDB | customer-defined. | |
| Timestamp | If 1 then matching frames will | |
| Enable | have timestamp fields | |
| | updated in the forwarding | |
| | headers. If excess latency | |
| | detect is enabled, this may | |
| | also cause the frame to be | |
| | discarded if the queuing | |
| | latency threshold is | |
| | exceeded. | |
| Timestamp Select | Selects which timestamp | Voice ≦10 ms, |
| | delay will be enforced. | video ≦100 ms |

Typical ingress frame processing is shown in Flowchart A with MPLS disabled. As shown in the Flowchart A, the first step in the processing is verifying that the Cyclic Redundancy Check (CRC) is correct. Typically, the device will be configured to drop ingress frames with a bad CRC and the device should default to that operation. Following the CRC check, a set of default assignments is made, as described in Table J. A Default Ingress Frame Handling Register exists for each port. As each frame passes through the control table and CoS assignment, a discard and CoS handling is associated with it. Unless overridden along the way, the default values will determine how the Active Queue Management (AQM) block handles this frame.

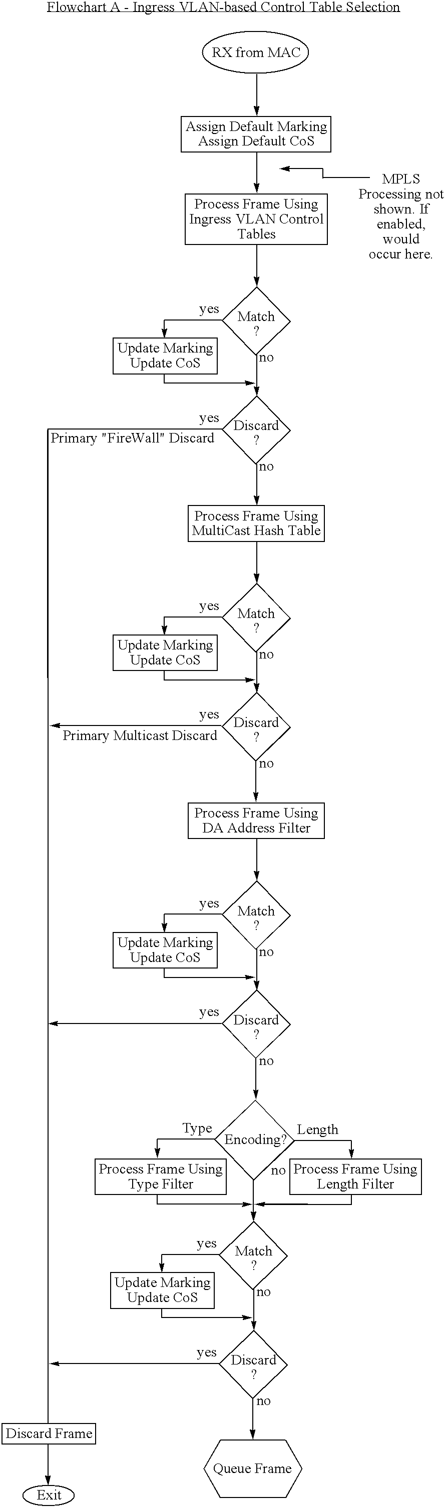

In order to coalesce the priority encodings of the divergent ingress VLANs, the device will maintain at least sixteen different priority mapping register sets. The register sets are a resource shared by the various ingress CoS filtering mechanisms. Each VLAN control table will allow a direct CoS assignment per VLAN match or point to one of the sixteen ingress priority mappings. Each register set will map the eight possible ingress QoS levels to the eight CoS levels of the device, permitting consistent priority regeneration to be accomplished, with the exception of the sixteenth table. This Extended QoS Mapping Table will extend the ingress QoS encoding bits to include the Canonical Format Indicator (CFI) bit.

TABLE 2
Default Ingress Frame Handling

| Field | Function | Comments |
|---|---|---|
| Discard | When set this field is | May be overridden whenever a |
| | used to set the default | match is found in one or more of |
| | ingress frame handling to | the subsequent filtering stages. |
| | discard | |
| CoS | Class of Service | Sets the default Class of Service. |
| | | Can be used to set port-based |
| | | CoS. |

A standard Ingress Priority Mapping Register set is shown in Table K. The “Ingress QoS” column represents that of the ingress traffic. The values in the “RedHawk CoS” column are those that the ingress QoS levels map to. The values given are industry defaults. The text in the comments also reflects the use anticipated by industry standards.

TABLE K
Ingress Priority Mapping Register Set (15x)

| Ingress | RedHawk | |
|---|---|---|
| QoS | CoS | Comments |
| 0 | 2 | Best effort |
| (no QoS) | | |
| 1 | 0 | Background (lowest) |
| 2 | 1 | Spare (undefined) |
| 3 | 3 | Excellent effort |
| 4 | 4 | Controlled load |
| 5 | 5 | Video |
| 6 | 6 | Voice |
| 7 | 7 | Network management |
| | | (highest) |

An example of the Extended QoS Mapping is shown in Table L

TABLE L
Extended Ingress Priority Mapping Register Set (1x)

| Ingress | Ingress | RedHawk | |
|---|---|---|---|
| CFI | QoS | CoS | Comments |
| 0 | 0 | 2 | |
| | 1 | 0 | |
| | 2 | 1 | |
| | 3 | 3 | |
| | 4 | 4 | |
| | 5 | 5 | |
| | 6 | 6 | |
| | 7 | 7 | |
| 1 | 0 | 2 | CFI is Discard Eligible bit |
| | 1 | 0 | |
| | 2 | 1 | |
| | 3 | 3 | |
| | 4 | 4 | |
| | 5 | 5 | |
| | 6 | 6 | |
| | 7 | 7 | |

Because the device can provide a variable number of queues (up to eight), different QoS-to-CoS mappings are anticipated.

In another embodiment the device of this invention inner vLAN approach. The Inner vLAN Control Table is only used when one vLAN tag is detected in the incoming frame. The flow of frames to the Outer vLAN Control Table follows that described in Flowchart A. Following CRC validation, the presence of a single tag, whose ethertypes are permitted by Table M is required.

TABLE M
VLAN Ethertype Default Entries

| | | | |
|---|---|---|---|
| 5 | 0x0000 | 0 | Available for use |
| 6 | 0x0000 | 0 | Available for use |
| 7 | 0x0000 | 0 | Available for use |
| 8 | 0x0000 | 0 | Available for use |
| 9 | 0x0000 | 0 | Available for use |
| 10 | 0x0000 | 0 | Available for use |
| 11 | 0x0000 | 0 | Available for use |
| 12 | 0x0000 | 0 | Available for use |
| 13 | 0x0000 | 0 | Available for use |
| 14 | 0x0000 | 0 | Available for use |
| 15 | 0x0000 | 0 | Available for use |

Because implementations exist which use Ethertype=0x8100 in both the inner and outer tags, it is necessary to parse the header frame in order to determine the number of vLAN tags which are present.

Table N provides the fields of the Inner vLAN Control Table and describes their use. The Inner vLAN Control Table consists of 4,096 entries, each one corresponding to one of the 4K possible vLAN IDs. The Outer vLAN ID is used to index into this table and find the control desired for a given vLAN.

Another single entry table is provided, which is applied when no vLAN ID is present. Its operation is described in Table O.

TABLE N
Inner VLAN Control Table Fields

| Field(s) | Function | Comments |
|---|---|---|
| Enable | Set to 1 to enable the | |
| | associated control table entries | |
| Discard | Causes frame to be discarded | Overrides the current Discard |
| | if set to 1 | status when a match is found. |
| CoS Type | Determines CoS assignment | The CoS value assigned here |
| | method. A two-bit field: | can be overridden if |
| | 0 -> Use CoS level C | subsequent MAC filtering, |
| | 1 -> Reserved | DSCP or MPLS filtering |
| | 2 -> Use QoS field of VLAN | explicitly assigns the CoS |
| | tag to map CoS using ingress | value. |
| | priority mapping set C | |
| | 3 -> Reserved | |
| C | CoS assignment: Either the | |
| | direct CoS value or a pointer to | |
| | one of the ingress priority | |
| | mapping sets. | |
| Tag Operation | Determines VLAN tag | The RedHawk will be required |
| | manipulation. A three-bit field: | to handle at most two sets of |
| | 0 -> no change to VLAN | VLAN tags. |
| | tags | |
| | 1 -> Pop (discard) the outer | |
| | tag | |
| | 2 -> Reserved | |
| | 3 -> Swap tag with field I | |
| | 4 -> Reserved | |
| | 5 -> Reserved | |
| | 6 -> Push (insert) tag I | |
| | 7 -> Reserved | |
| I | Eight bit index to Ingress VLAN | |
| | ID table. | |
| MAC DA filter | If 1 then matching frames will | Should default to 1. MAC |
| Enable | pass through the common DA | filtering always occurs before |
| | MAC filter, | any additional filtering. |
| MAC multicast | If 1 then matching frames will | Should default to 1. |
| hash filter | pass through the multicast | |
| Enable | hash filter. | |
| MAC type filter | If 1 then matching frames will | Should default to 1. |
| Enable | pass through the common MAC | |
| | type filter. | |
| MAC | If 1 then matching frames will | Should default to 1. |
| LLC/SNAP | pass through the common MAC | |
| filter Enable | type filter. | |
| DSCP Filter | If 1 then matching frames will | |
| | pass through the common | |
| | DSCP filter. | |
| IP Protocol | If 1 then matching frames will | |
| Filter | pass through the common IP | |
| | protocol filter. | |
| Timestamp | If 1 then matching frames will | |
| Enable | have timestamp fields updated | |
| | in the forwarding headers. If | |
| | excess latency detect is | |
| | enabled, this may also cause | |
| | the frame to be discarded if the | |
| | queuing latency threshold is | |
| | exceeded. | |
| Timestamp | Selects which timestamp delay | Voice ≦10 ms, video ≦100 ms |
| Select | will be enforced. | |
| VLAN Priority | If 1, then overwrite the priority | |
| Overwrite | field of the outermost VLAN tag | |
| | with the final VLAN priority | |
| | assigned to the frame. | |
| IDD1 | The value stored here will be | Used to implement customer- |
| Programmable | used in the ingress forwarding | specific functions |
| Bit | header IDD1 programmable bit. | |

TABLE O
No VLAN Tag Control Table Fields

| Field(s) | Function | Comments |
|---|---|---|
| Enable | Set to 1 to enable the | |
| | associated control table entries | |
| Discard | Causes frame to be discarded | Overrides the current Discard |
| | if set to 1 | status when a match is found. |
| CoS Type | Determines CoS assignment | The CoS value assigned here |
| | method. A two-bit field: | can be overridden if |
| | 0 -> Use CoS level C | subsequent MAC filtering or |
| | 1 -> Reserved | IP filtering explicitly assigns |
| | 2 -> Reserved | the CoS value. |
| | 3 -> Reserved | |
| C | CoS assignment: Either the | |
| | direct CoS value or a pointer to | |
| | one of the ingress priority | |
| | mapping sets. | |
| Tag Operation | Determines VLAN tag | |
| | manipulation. A three-bit field: | |
| | 0 -> no change | |
| | 1 -> Reserved | |
| | 2 -> Reserved | |
| | 3 -> Reserved | |
| | 4 -> Reserved | |
| | 5 -> Reserved | |
| | 6 -> Push (insert) tag I | |
| | 7 -> Double Push (insert) | |
| | tags I and J | |
| I | Eight bit index to Ingress VLAN | |
| | ID table. | |
| J | Eight bit index to Ingress VLAN | |
| | ID table. | |
| MAC DA filter | If 1 then matching frames will | Should default to 1. MAC |
| Enable | pass through the common DA | filtering always occurs before |
| | MAC filter, | any additional filtering. |
| MAC multicast | If 1 then matching frames will | Should default to 1. |
| hash filter | pass through the multicast | |
| Enable | hash filter. | |
| MAC type filter | If 1 then matching frames will | Should default to 1. |
| Enable | pass through the common MAC | |
| | type filter. | |
| MAC | If 1 then matching frames will | Should default to 1. |
| LLC/SNAP | pass through the common MAC | |
| filter Enable | type filter. | |
| DSCP Filter | If 1 then matching frames will | |
| | pass through the common | |
| | DSCP filter. | |
| IP Protocol | If 1 then matching frames will | |
| Filter | pass through the common IP | |
| | protocol filter. | |
| Timestamp | If 1 then matching frames will | |
| Enable | have timestamp fields updated | |
| | in the forwarding headers. If | |
| | excess latency detect is | |
| | enabled, this may also cause | |
| | the frame to be discarded if the | |
| | queuing latency threshold is | |
| | exceeded. | |
| Timestamp | Selects which timestamp delay | Voice ≦10 ms, video ≦100 ms |
| Select | will be enforced. | |
| VLAN Priority | If 1, then overwrite the priority | |
| Overwrite | field of the outermost VLAN tag | |
| | with the final VLAN priority | |
| | assigned to the frame. | |
| IDD1 | The value stored here will be | Used to implement customer- |
| Programmable | used in the ingress forwarding | specific functions |
| Bit | header IDD1 programmable bit. | |

The various vLAN Control Tables contain indices (designated as I or J) that are used to provide a lookup in the Ingress vLAN ID Table. Essentially the Ingress vLAN ID Table is used to conserve control table bits. It contains 256 entries, each of which contains a four-byte user programmable vLAN tag, complete with Ethertype bytes. See also Table P.

TABLE P
Ingress VLAN ID Table

| Entry # | VLAN Tag | Description |
|---|---|---|
| 0 | 0x8100 | IEEE 802.1p format |
| | 0x0000 | |
| . . . | . . . | Available |
| 255 | VLAN Tag | Available |

The QoS bits can be overwritten as desired.

The device of this invention also employees outer vLAN approach to manage oversubscription and the flow of frames generally follows that described in Flowchart A. Following CRC validation, the presence of two tags, whose ethertypes are permitted by Table M (or a match with Table S), is required.

For an S-vLAN Ethertype a single-entry table is provided, as shown in Table S1. Here the Ethertype decode to be used for S-VLANs is defined. In order to handle the additional ambiguity associated with this Ethertype, additional parameters are defined for it, as shown in Table S.

TABLE S1
S-VLAN Ethertype

| Ethertype | Discard | Description |
|---|---|---|
| TBD | 0 | IEEE 802.1ad. |

Because both the S-vLAN and normal vLAN tags use the Inner and Outer vLAN Control Table, multiple S-vLANs will map to a single Inner or Outer vLAN Control Table entry.

TABLE S
S-VLAN Ethertype Match Table Control Usage

| Field | Function | Comments |
|---|---|---|
| Enable | Disables functionality when 0 | |
| Discard | When set frames with this | |
| | ethertype are discarded | |
| Length | Provides the length, in | Six (6) octets will probably be |
| | octets, of the S-VLAN tag | standardized. However, values of 4 to |
| | (including Ethertype octets) | 16 should be accepted. |
| QoS Offset | The QoS field offset, in bits | The QoS bits are assumed |
| | | consecutive. |
| S-VLAN ID | The S-VLAN ID offset, in | The next 12 bits may be decoded |
| Offset | bits | using the Outer VLAN Control Table. |

S-vLAN Ethertype CoS determination is made using a CFI bit=0 default assignment. S-vLAN Ethertype is treated the same as a standard VLAN Ethertype, in that the S-vLAN Ethertype may be the inner or outer vLAN tag. The Inner and Outer vLAN Control Table references to push, double push, pop, double pop and swap and not applicable to S-vLANs.

Table RR provides the fields of the Outer VLAN Control Table and describes their use. Note the Outer VLAN Control Table consists of 4,096 entries, each one corresponding to one of the 4K possible VLAN IDs. The Outer VLAN ID is used to index into this table and find the control desired for a given vLAN.

TABLE Q
Ingress QoS to Internal CoS for Different Queue Counts

| Ingress | Number of CoS Queues | | | | | | | |
|---|---|---|---|---|---|---|---|---|
| QoS | 1 | 2 | 3 | 4 | 5 | 6 | 7 | 8 |
| 0 (no QoS) | 0 | 0 | 0 | 1 | 1 | 1 | 1 | 2 |
| 1 | 0 | 0 | 0 | 0 | 0 | 0 | 0 | 0 |
| 2 | 0 | 0 | 0 | 0 | 0 | 0 | 0 | 1 |
| 3 | 0 | 0 | 0 | 1 | 1 | 2 | 2 | 3 |
| 4 | 0 | 1 | 1 | 2 | 2 | 3 | 3 | 4 |
| 5 | 0 | 1 | 1 | 2 | 3 | 4 | 4 | 5 |
| 6 | 0 | 1 | 2 | 3 | 4 | 5 | 5 | 6 |
| 7 | 0 | 1 | 2 | 4 | 4 | 5 | 6 | 7 |

It is also desirable for the device to perform these operations in the presence of any (reasonable) number of vLAN tags. In every case, however, the functionality described here done on the two outermost tags only.

TABLE R
Outer VLAN Control Table Fields

| Field(s) | Function | Comments |
|---|---|---|
| Enable | Set to 1 to enable the associated | |
| | control table entries | |
| Discard | Causes frame to be discarded if | Overrides the current |
| | set to 1 | Discard status when a |
| | | match is found. |
| CoS Type | Determines CoS assignment | The CoS value assigned |
| | method. A two-bit field: | here can be overridden if |
| | 0 -> Use CoS level C | subsequent MAC filtering, |
| | 1 -> Reserved | DSCP or MPLS filtering |
| | 2 -> Use QoS field of inner | explicitly assigns the CoS |
| | VLAN tag to map CoS using | value. |
| | ingress priority mapping set C | |
| | 3 -> Use QoS field of outer | |
| | VLAN tag to map CoS using | |
| | ingress priority mapping set C | |
| C | CoS assignment: Either the | |
| | direct CoS value or a pointer to | |
| | one of the ingress priority | |
| | mapping sets. | |
| Tag Operation | Determines VLAN tag | The RedHawk will be |
| | manipulation. A three-bit field: | required to handle at most |
| | 0 -> no change to VLAN tags | two sets of VLAN tags. |
| | 1 -> Pop (discard) the outer | |
| | tag | |
| | 2 -> Double Pop (discard) the | |
| | inner and outer tags | |
| | 3 -> Swap Inner tag with I | |
| | 4 -> Swap Outer tag with I | |
| | I = Eight bit index to Ingress | |
| | VLAN ID table. | |
| MAC DA filter | If 1 then matching frames will | Should default to 1. MAC |
| Enable | pass through the common DA | filtering always occurs |
| | MAC filter (described in Section | before any additional |
| | 0) | filtering. |
| MAC hash | If 1 then matching frames will | Should default to 1. |
| filter Enable | pass through the hash filter | |
| | (described in Section 0) | |
| MAC type filter | If 1 then matching frames will | Should default to 1. |
| Enable | pass through the common MAC | |
| | type filter. | |
| MAC | If 1 then matching frames will | Should default to 1. |
| LLC/SNAP | pass through the common MAC | |
| filter Enable | type filter. | |
| DSCP Filter | If 1 then matching frames will | |
| | pass through the common DSCP | |
| | filter. | |
| IP Protocol | If 1 then matching frames will | |
| Filter | pass through the common IP | |
| | protocol filter. | |
| Timestamp | If 1 then matching frames will | |
| Enable | have timestamp fields updated in | |
| | the forwarding headers. If excess | |
| | latency detect is enabled, this | |
| | may also cause the frame to be | |
| | discarded if the queuing latency | |
| | threshold is exceeded. | |
| Timestamp | Selects which timestamp delay | Voice ≦10 ms, video ≦100 ms |
| Select | will be enforced. | |
| VLAN Priority | If 1, then overwrite the priority | |
| Overwrite | field of the outermost VLAN tag | |
| | with the final VLAN priority | |
| | assigned to the frame. | |
| IDD1 | The value stored here will be | Used to implement |
| Programmable | used in the ingress forwarding | customer-specific functions |
| Bit | header IDD1 programmable bit. | |

The device of this invention also employees Media Access Control (MAC) based Destination Address (DA) and Source Address (SA) approaches to manage oversubscription. The MAC filters run as parallel filters. If matches are found in multiple filters then the highest priority CoS (of entries not set to “Discard”) is used. If both “Discard” and “Don't Discard” are matched in the filters the frame must not be discarded, i.e., it will only be discarded if all filters decode to discard.

### DA Address Filtering

The MAC DA Filter Registers are shown in Table T. Each filter register has a mask register associated with it, as shown in Table U, and a priority register, as shown in Table V.

The DA field of frames entering the MAC filter is masked by the masks of Table U and then compared with the values in Table T. When a match is found, the associated CoS assignment register is used to assign the CoS field. If not marked for discard, filtering then continues with the Type/Length filtering.

Typical filter arrangement in a classification engine is shown in the Flowchart B.

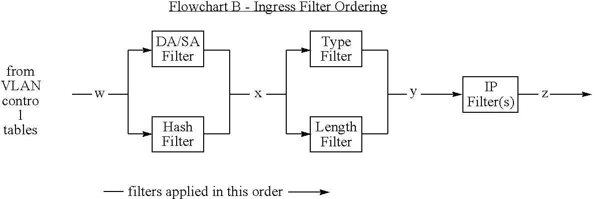

Note that the Discard Eligibility bit is evaluated at the points labeled w, x, y and z in Flowchart B. If this bit indicates discard from all of the immediately previous filters the frame will be discarded and no further filtering will take place. In MAC arrangement filters are applied in parallel to each ingress frame.

TABLE T
MAC Destination Address Filter Register

| Register | Default Value | Comments |
|---|---|---|
| MAC DA Match Register 0 | 01-80-C2-00-00-00 | Reserved Local |
| | | Control |
| MAC DA Match Register 1 | FF-FF-FF-FF-FF-FF | Broadcast |
| MAC DA Match Register 2 | 00-00-00-00-00-00 | Available |
| MAC DA Match Register 3 | 00-00-00-00-00-00 | Available |
| MAC DA Match Register 4 | 00-00-00-00-00-00 | Available |
| MAC DA Match Register 5 | 00-00-00-00-00-00 | Available |
| MAC DA Match Register 6 | 00-00-00-00-00-00 | Available |
| MAC DA Match Register 7 | 00-00-00-00-00-00 | Available |

A mask register with all zeroes content disables the associated MAC DA filter.

TABLE U
MAC Destination Address Mask Register

| Register | Default Value | Comments |
|---|---|---|
| MAC DA Mask Register 0 | FF-FF-FF-00-00-00 | Reserved Local |
| | | Control |
| MAC DA Mask Register 1 | FF-FF-FF-FF-FF-FF | Broadcast |
| MAC DA Mask Register 2 | 00-00-00-00-00-00 | Disabled by default |
| MAC DA Mask Register 3 | 00-00-00-00-00-00 | Disabled by default |
| MAC DA Mask Register 4 | 00-00-00-00-00-00 | Disabled by default |
| MAC DA Mask Register 5 | 00-00-00-00-00-00 | Disabled by default |
| MAC DA Mask Register 6 | 00-00-00-00-00-00 | Disabled by default |
| MAC DA Mask Register 7 | 00-00-00-00-00-00 | Disabled by default |

If multiple entries match, the frame will be placed into the highest priority queue of those matching entries.

TABLE V
MAC DA Match Control Register Usage (x8)

| Field(s) | Function | Comments |
|---|---|---|
| Discard | Causes frame to be discarded | Overrides the current Discard |
| | if set to 1 | status when a match is found. |
| CoS Type | Determines CoS assignment | The CoS value assigned here |
| | method. A two-bit field: | can be overridden if |
| | 0 -> Use CoS level C | subsequent IP filtering |
| | 1 -> Reserved | explicitly assigns the CoS |
| | 2 -> Reserved | value. |
| | 3 -> Reserved | |
| C | CoS assignment: the direct | |
| | CoS value | |
| IDD2 | The value stored here will be | Used to implement customer-specific |
| Programmable Bit | used in the ingress forwarding | functions |
| | header IDD2 programmable | |
| | bit. | |

Note that the programming of the CoS assignments values made using the MAC DA Match Registers must be made in descending CoS order (seven (7) is the highest, zero (0) is the lowest). For example, the CoS assignment made using MAC DA Filter Register 0 must be greater than or equal to that of Register 1. If a multicast DA is desired, certain bit needs to be set to equal 1, as this bit position will determine a unicast or multicast transmission.

### Hash Filtering

Each port of the device of this invention will provide a 64-bit hash table. The hash table may be assigned to hash over DA, multicast DA or SA fields; only one of the three may be selected at any given time. The hash table serves all ingress vLAN associated with this port. The hashed field should default to multicast DA. For the multicast DA case, the hash table must decode the DA only if it is a layer-2 multicast address (that is, the first bit of the MAC address is 1). If the hash filter is enabled, the ingress field is used as input to a 6-bit CRC. The resulting value is used to index into a 64-bit long hash table. If the hash table bit is set then the address is considered to match. The action taken upon a hash table match is shown in Table W

TABLE W
Hash Filter Assignment Register

| Field(s) | Function | Comments |
|---|---|---|
| Discard | Causes frame to be discarded | Overrides the current Discard |
| | if set to 1 | status when a match is found. |
| CoS Type | Determines CoS assignment | The CoS value assigned here |
| | method. A two-bit field: | can be overridden if |
| | 0 -> Use CoS level C | subsequent IP filtering |
| | 1 -> Reserved | explicitly assigns the CoS |
| | 2 -> Reserved | value. |
| | 3 -> Reserved | |
| C | CoS assignment: The direct | |
| | CoS value | |
| IDD3 | The value stored here will be | Used to implement customer-specific |
| Programmable Bit | used in the ingress forwarding | functions |
| | header IDD3 programmable | |
| | bit. | |

The device software driver must encode the hash table addresses that it desires to filter by running the CRC function over the ingress DA and then using that to set/reset the appropriate hash table bit. In addition, the Network Processing Unit (NPU) may have to filter out multicast frames that ingress due to hash bin collisions. The CRC generator polynomial employed here is:
g(x)=x⁶+x+1

In another embodiment the device of this invention also employees Layer 2 Ethertype for managing ovesubscription.

### Type/Length Field Filtering

As shown in Diagram 1, every Ethernet frame contains a Type/Length field. The device will permit filtering of all incoming frames based on the MAC Type/Field contents.

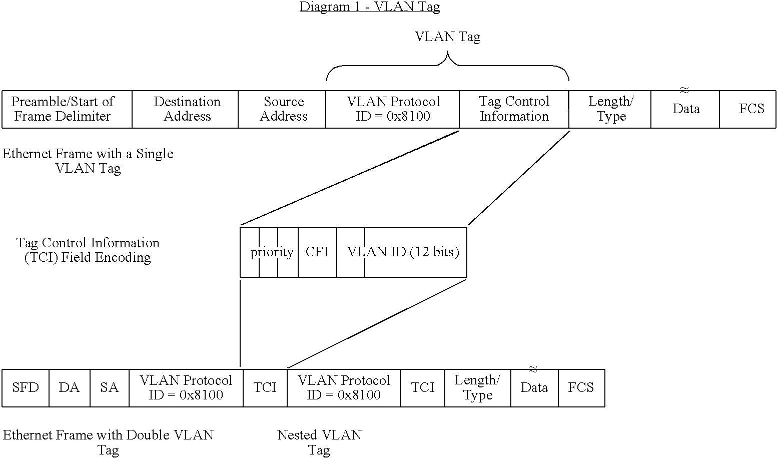

Either Type or Length filtering is used, based on the contents of the Type/Length field, as clarified in Table W1.

TABLE W1
Type vs. Length Determination

| Type/Length Contents | Results | Comments |
|---|---|---|
| Field ≦0x05DC | Length filtering | |
| 0x05DC < Field < 0x0600 | Invalid | Illegal frame - discard |
| 0x0600 ≦ Field | Type filtering | |

The device provides twenty-four programmable Type Field Match Registers, with the default values as shown in Table X. Writing zero to a register can be used to disable a match register. As done previously, each match register has an associated assignment register that is used to determine the disposition of matching frames.

TABLE X
Type Field Match Register Usage

| Register | Default Value | Comments |
|---|---|---|
| Type Field Match Register 0 | 0x0800 | IPv4 |
| Type Field Match Register 1 | 0x0806 | IP-ARP |
| Type Field Match Register 2 | 0x6001 | DEC MOP |
| Type Field Match Register 3 | 0x6002 | DEC MOP |
| Type Field Match Register 4 | 0x6003 | DECnet Routing |
| | | Protocol |
| Type Field Match Register 5 | 0x6004 | DEC LAT |
| Type Field Match Register 6 | 0x6005 | DEC Diagnostics |
| Type Field Match Register 7 | 0x6006 | DEC Diagnostics |
| Type Field Match Register 8 | 0x8035 | IP-RARP |
| Type Field Match Register 9 | 0x8038 | DEC Spanning Tree |
| Type Field Match Register 10 | 0x803D | DEC Ethernet |
| | | Encryption |
| Type Field Match Register 11 | 0x803F | DEC LAN Monitor |
| Type Field Match Register 12 | 0x809B | AppleTalk |
| Type Field Match Register 13 | 0x80F3 | AppleTalk ARP |
| Type Field Match Register 14 | 0x8137 | IPX |
| Type Field Match Register 15 | 0x86DD | IPv6 |
| Type Field Match Register 16 | 0x8808 | MAC control |
| Type Field Match Register 17 | 0x8809 | Slow protocol |
| Type Field Match Register 18 | 0x8870 | Jumbo frames |
| Type Field Match Register 19 | 0x8847 | MPLS unicast |
| Type Field Match Register 20 | 0x8848 | MPLS multicast |
| Type Field Match Register 21 | 0x0000 | Available |
| Type Field Match Register 22 | 0x0000 | Available |
| Type Field Match Register 23 | 0x0000 | Available |
| Type Field Match Register 24 | 0x0000 | Available |

Type/Length field filtering is done on the first tag not matching those shown in the MPLS, S vLAN and vLAN ID registers Note that if LLC/SNAP encoding is used in the ingress frame these registers will not apply. Each register has an associated Priority Assignment Register, an example of which is shown in Table Y.

TABLE Y
Type Field Match Priority Assignment Register Usage (x24)

| Field(s) | Function | Comments |
|---|---|---|
| Enable | A 0 disables this function | |
| Discard | Causes frame to be discarded | Overrides the current |
| | if set to 1 | Discard status when a |
| | | match is found. |
| CoS Type | Determines CoS assignment | The CoS value assigned |
| | method. A two-bit field: | here can be overridden if |
| | 0 -> Use CoS level C | subsequent IP filtering |
| | 1 -> Reserved | explicitly assigns the |
| | 2 -> Reserved | CoS value. |
| | 3 -> Reserved | |
| C | CoS assignment: the direct | |
| | CoS value | |
| IDD4 | The value stored here will be | Used to implement |
| Programmable | used in the ingress forwarding | customer-specific |
| Bit | header IDD4 programmable | functions |
| | bit. | |

If none of the Type Field Match Registers find a match, a default handling can be applied. The control will be identical to that for the Type Field Match Registers and is shown in Table Z.

TABLE Z
Other Type Field Match Priority Assignment Register Usage

| Field(s) | Function | Comments |
|---|---|---|
| Enable | A 0 disables this function | |
| Discard | Causes frame to be discarded | Overrides the current |
| | if set to 1 | Discard status when a |
| | | match is found. |
| CoS Type | Determines CoS assignment | The CoS value assigned |
| | method. A two-bit field: | here can be overridden if |
| | 0 -> Use CoS level C | subsequent IP filtering |
| | 1 -> Reserved | explicitly assigns the |
| | 2 -> Reserved | CoS value. |
| | 3 -> Reserved | |
| C | CoS assignment: the direct | |
| | CoS value | |
| IDD4 | The value stored here will be | Used to implement |
| Programmable | used in the ingress forwarding | customer-specific |
| Bit | header IDD4 programmable | functions |
| | bit. | |

Length Field (LLC/SNAP) Filtering

The device of this invention will filter for frames using LLC/SNAP encoding, which implies that the Type/Length field of the incoming Ethernet frame contains a value of 0x5DC or less. The format of an LLC/SNAP-encoded frame is shown in Diagram 2. LLC/SNAP frames with vLAN tags should also be accepted and filtered properly. Filtering based on LLC/SNAP encoding is fairly complex and can result in the following outcomes:

1) Pure LLC encapsulations

2) Raw 802.3 encapsulation

3) RFC 1042 encoding (use Type Match control mechanism)

4) 802.1H bridge tunneling

5) AppleTalk

6) Unknown protocols (or bad encapsulations)

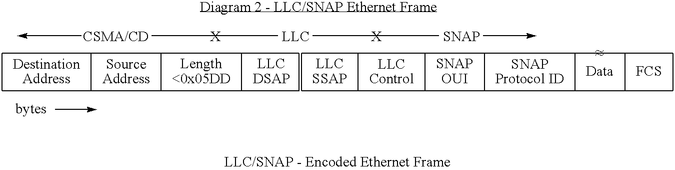

The decision flow is shown in F. This type of decode is needed in order to locate the Bridge Protocol Data Unit (BPDU) using length field values. Note that BPDUs can also be located using their distinct DA (01-80-C2-00-00-00). The associated control registers are described below. The NetBIOS Control Register is shown in Table A1.

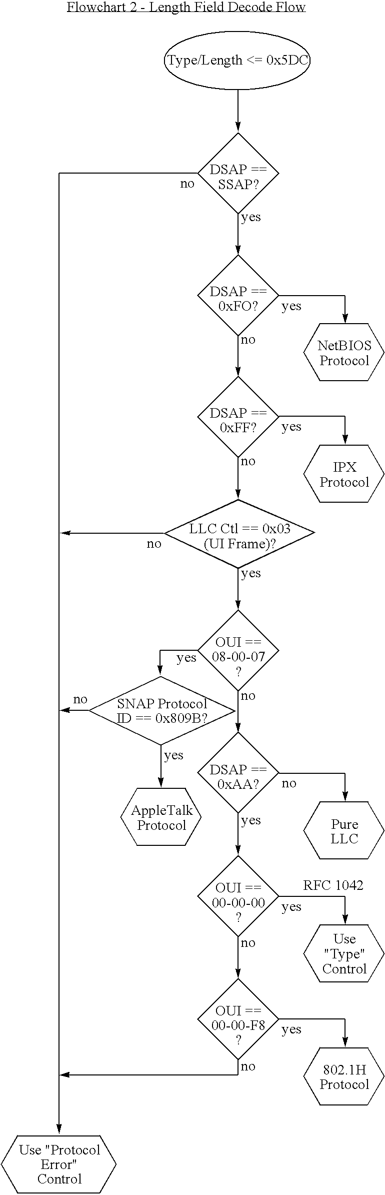

TABLE A1
NetBIOS Control Register

| Field(s) | Function | Comments |
|---|---|---|
| Enable | A 0 disables this function | |
| Discard | Causes frame to be | Overrides the current |
| | discarded if set to 1 | Discard status when a |
| | | match is found. |
| CoS Type | Determines CoS assignment | The CoS value assigned |
| | method. A two-bit field: | here should not be |
| | 0 -> Use CoS level C | overridden with the IP |
| | 1 -> Reserved | control register. |
| | 2 -> Reserved | |
| | 3 -> Reserved | |
| C | CoS assignment: the direct | |
| | CoS value | |
| IDD5 | The value stored here will be | Used to implement |
| Programmable | used in the ingress forwarding | customer-specific |
| Bit | header IDD5 programmable | functions |
| | bit. | |

The IPX Control Register is provided in Table B1.

TABLE B1
IPX Control Register

| Field(s) | Function | Comments |
|---|---|---|
| Enable | A 0 disables this function | |
| Discard | Causes frame to be discarded | Overrides the current |
| | if set to 1 | Discard status when a |
| | | match is found. |
| CoS Type | Determines CoS assignment | The CoS value assigned |
| | method. A two-bit field: | here should not be |
| | 0 -> Use CoS level C | overridden with the IP |
| | 1 -> Reserved | control register. |
| | 2 -> Reserved | |
| | 3 -> Reserved | |
| C | CoS assignment: the direct | |
| | CoS value | |
| IDD5 | The value stored here will be | Used to implement |
| Programmable | used in the ingress forwarding | customer-specific |
| Bit | header IDD5 programmable | functions |
| | bit. | |

The AppleTalk Control Register is depicted in Table C1.

TABLE C1
AppleTalk Control Register

| Field(s) | Function | Comments |
|---|---|---|
| Enable | A 0 disables this function | |
| Discard | Causes frame to be discarded | Overrides the current |
| | if set to 1 | Discard status when a |
| | | match is found. |
| CoS Type | Determines CoS assignment | The CoS value assigned |
| | method. A two-bit field: | here should not be |
| | 0 -> Use CoS level C | overridden with the |
| | 1 -> Reserved | IP control register. |
| | 2 -> Reserved | |
| | 3 -> Reserved | |
| C | CoS assignment: the direct | |
| | CoS value | |
| IDD5 | The value stored here will be | Used to implement |
| Programmable | used in the ingress forwarding | customer-specific |
| Bit | header IDD5 programmable | functions |
| | bit. | |

The Pure LLC Control mechanism first matches the SAP field with one of the four LLC SAP Registers, as shown in Table D1.

TABLE D1
Pure LLC Match Registers

| Entry # | SAP | Description |
|---|---|---|
| 0 | 0x06 | A non-standard encoding for IP |
| 1 | 0x42 | 802.1D Spanning Tree |
| 2 | 0xE0 | IPX/SPX (802.2 encap) |
| 3 | 0xFE | ISO 8473 CLNP |

When a match is found, the control is determined using the associated Pure LLC Assignment Registers, provided in Table E1.

TABLE E1
Pure LLC Assignment Register (4x)

| Field(s) | Function | Comments |
|---|---|---|
| Enable | A 0 disables this function | |
| Discard | Causes frame to be discarded | Overrides the current |
| | if set to 1 | Discard status when a |
| | | match is found. |
| CoS Type | Determines CoS assignment | The CoS value assigned |
| | method. A two-bit field: | here should not be |
| | 0 -> Use CoS level C | overridden with the |
| | 1 -> Reserved | IP control register. |
| | 2 -> Reserved | |
| | 3 -> Reserved | |
| C | CoS assignment: the direct | |
| | CoS value | |
| IDD5 | The value stored here will be | Used to implement |
| Programmable | used in the ingress forwarding | customer-specific |
| Bit | header IDD5 programmable | functions |
| | bit. | |

If no match is made, then the Other LLC Assignment Register, described in Table F1, is used.

TABLE F1
Other LLC Control Register

| Field(s) | Function | Comments |
|---|---|---|
| Enable | A 0 disables this function | |
| Discard | Causes frame to be discarded | Overrides the current |
| | if set to 1 | Discard status when |
| | | a match is found. |
| CoS Type | Determines CoS assignment | The CoS value assigned |
| | method. A two-bit field: | here should not be |
| | 0 -> Use CoS level C | overridden with the |
| | 1 -> Reserved | IP control register. |
| | 2 -> Reserved | |
| | 3 -> Reserved | |
| C | CoS assignment: the direct | |
| | CoS value | |
| IDD5 | The value stored here will | Used to implement |
| Programmable | be used in the ingress | customer-specific |
| Bit | forwarding header IDD5 | functions |
| | programmable bit. | |

The 802.1H Bridge Tunneling Control Register is provided in Table G1.

TABLE G1
802.1H Bridge Tunneling Control Register

| Field(s) | Function | Comments |
|---|---|---|
| Enable | A 0 disables this function | |
| Discard | Causes frame to be | Overrides the current Discard |
| | discarded if set to 1 | status when a match is found. |
| CoS Type | Determines CoS | The CoS value assigned here |
| | assignment method. | should not be overridden with |
| | A two-bit field: | the IP control register. |
| | 0 -> Use CoS level C | |
| | 1 -> Reserved | |
| | 2 -> Reserved | |
| | 3 -> Reserved | |
| C | CoS assignment: | |
| | the direct | |
| | CoS value | |
| IDD5 | The value stored here | Used to implement customer- |
| Programmable | will be used in the | specific functions |
| Bit | ingress forwarding | |
| | header IDD5 | |
| | programmable bit. | |

The Unknown Protocol Control Register is shown in Table H1.

TABLE H1
Unknown Protocol Control Register

| Field(s) | Function | Comments |
|---|---|---|
| Enable | A 0 disables this function | |
| Discard | Causes frame to be | Overrides the current Discard |
| | discarded if set to 1 | status when a match is found. |
| CoS Type | Determines CoS | The CoS value assigned here |
| | assignment method. | should not be overridden with |
| | A two-bit field: | the IP control register. |
| | 0 -> Use CoS level C | |
| | 1 -> Reserved | |
| | 2 -> Reserved | |
| | 3 -> Reserved | |
| C | CoS assignment: | |
| | the direct | |
| | CoS value | |
| IDD5 | The value stored here | Used to implement customer- |
| Programmable | will be used in the | specific functions |
| Bit | ingress forwarding | |
| | header IDD5 | |
| | programmable bit. | |

The frames with a Type/Length field with contents greater than 0x5DC and less than 0x600 are illegal frames and need to be discarded and counted in the MAC statistics frames.

In another embodiment the device of this invention employees Internet Protocol to manage oversubscription.

The IP Protocol filter can be used to find User Data Gram Protocol (UDP) packets, which may carry VoIP traffic. The IP Protocol filters use the IP version number, as found by the DSCP filter, to locate the protocol field. The location of the protocol fields for IPv4 and IPv6 is shown in Diagram 3 and Diagram 4 respectively. The decode of the IPv4 TOS (Type of Service) and IPv6 Traffic Class octets are shown in Diagram 5. 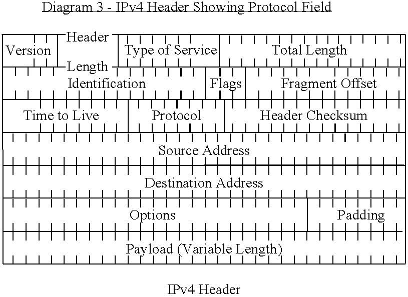
When IP protocol filtering is enabled the protocol field is used to find a match in the IP Protocol Match Registers, as shown in Table 12. Table 12 also shows a typical Layer 3 protocol arrangement. Each match register has a control register associated with it. When a protocol match is found, the associated control register dictates how the CoS and discard eligibility for that frame will be handled, as shown in Table J1.

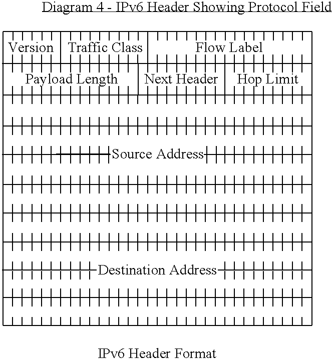

If no match is found, then control passes to the Default IP Protocol Control Register, as shown in Table K1.

TABLE I2
IP Protocol Match Registers

| Entry # | Protocol ID | Description |
|---|---|---|
| 0 | 0x06 | TCP |
| 1 | 0x11 | UDP |
| 2 | 0x02 | IGMP |
| 3 | 0x01 | ICMP |

TCP is Transmission Control Protocol

UDP is User Data Gram Protocol

IGMP is Internet Group Management Protocol

ICMP is Internet Control Management Protocol

TABLE J1
IP Protocol Assignment Register (x4)

| Field(s) | Function | Comments |
|---|---|---|
| Enable | A 0 disables this function | |
| Discard | Causes frame to be discarded if | |
| | set to 1 | |
| CoS Type | Determines CoS assignment | The CoS value |
| | method. A two-bit field: | assigned here |
| | 0 -> Use CoS level C | cannot be overridden. |
| | 1 -> Reserved | |
| | 2 -> Reserved | |
| | 3 -> Reserved | |
| C | CoS assignment: the direct CoS | |
| | value | |
| Timestamp | If 1 then matching frames will | |
| Enable | have timestamp fields updated in | |
| | the forwarding headers. If excess | |
| | latency detect is enabled, this may | |
| | also cause the frame to be | |
| | discarded if the queuing latency | |
| | threshold is exceeded. | |
| Timestamp | Selects which timestamp delay | Typically: |
| Select | will be enforced. | Voice ≦ 10 ms, |
| | | video ≦ 100 ms |

TABLE K1
Default IP Protocol Assignment Register

| Field(s) | Function | Comments |
|---|---|---|
| Enable | A 0 disables this function | |
| Discard | Causes frame to be discarded if | |
| | set to 1 | |
| CoS Type | Determines CoS assignment | The CoS value |
| | method. A two-bit field: | assigned here |
| | 0 -> Use CoS level C | cannot be overridden. |
| | 1 -> Reserved | |
| | 2 -> Reserved | |
| | 3 -> Reserved | |
| C | CoS assignment: the direct CoS | |
| | value | |
| Timestamp | If 1 then matching frames will | |
| Enable | have timestamp fields updated in | |
| | the forwarding headers. If excess | |
| | latency detect is enabled, this | |
| | may also cause the frame to be | |
| | discarded if the queuing latency | |
| | threshold is exceeded. | |
| Timestamp | Selects which timestamp delay | Typically: |
| Select | will be enforced. | Voice ≦ 10 ms, |
| | | video ≦ 100 ms |

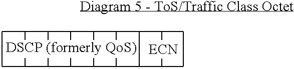

In another embodiment the device of this invention employees Differential Service Code Point (DSCP) filtering for oversubscription management. The device will classify frames containing DiffServ Code Points (DSCP). This takes places after the VLAN and MAC filters, described previously, have been applied. If DSCP classification is enabled, the device will use the contents of the DSCP Type Field Match Registers to determine which Ethernet frames contain the desired IP packets. Each of these registers contains a “Z” nibble. The interpretation of the “Z” nibble is described below.

TABLE L1
DSCP Type Field Match Registers

| | Default | |
|---|---|---|
| Register | Value | Comments |
| DSCP Type Field | 0xZ0800 | IPv4 - Z = 0x1 |
| Match Register 0 | | |
| DSCP Type Field | 0xZ86DD | IPv6 - Z = 0x2 |
| Match Register 1 | | |
| DSCP Type Field | 0xZ8847 | MPLS unicast - Z = 0x3 |
| Match Register 2 | | |
| DSCP Type Field | 0xZ8848 | MPLS multicast - Z = 0x3 |
| Match Register 3 | | |
| DSCP Type Field | 0xZ0000 | Available |
| Match Register 4 | | |
| DSCP Type Field | 0xZ0000 | Available |
| Match Register 5 | | |
| DSCP Type Field | 0xZ0000 | Available |
| Match Register 6 | | |
| DSCP Type Field | 0xZ0000 | Available |
| Match Register 7 | | |

For DSCP, this nibble is used to locate the DSCP-bearing byte, as encoded in Table N1. If none of the type fields match, then control frame will be processed as described by the DSCP Default Match Register. This register is described in Table M1. No further DSCP filtering is available to frames that are controlled by this register. In order to classify frames the device locates frames that contain IP packets. It must also be able to discern whether they are IPv4/IPv6 or some other protocol packets.

TABLE M1
DSCP Default Match Register

| Field(s) | Function | Comments |
|---|---|---|
| Enable | A 0 disables this function | |
| Discard | Causes frame to be discarded if | |
| | set to 1 | |
| CoS Type | Determines CoS assignment | Frames with |
| | method. A two-bit field: | a mismatched type |
| | 0 -> Use CoS level C | field enter this |
| | 1 -> Reserved | CoS if not discarded. |
| | 2 -> Reserved | |
| | 3 -> Reserved | |
| C | CoS assignment: the direct | |
| | CoS value | |
| IDD6 | The value stored here will be | Used to implement |
| Programmable | used in the ingress forwarding | customer-specific |
| Bit | header IDD6 programmable bit. | functions |
| Timestamp | If 1 then matching frames will | |
| Enable | have timestamp fields updated | |
| | in the forwarding headers. If | |
| | excess latency detect is | |
| | enabled, this may also cause | |
| | the frame to be discarded if the | |
| | queuing latency threshold is | |
| | exceeded. | |
| Timestamp | Selects which timestamp delay | Typically: |
| Select | will be enforced. | Voice ≦ 10 ms, |
| | | video ≦ 100 ms |

The type field in Ethernet packets is used to find frames containing IPv4 and IPv6 packets. Even though IPv4 labels the octet the “Type of Service” (ToS) byte and IPv6 labels it the “Traffic Class” byte, both protocols use the same coding for classifying traffic. Industry standards define these DiffServ values. They are described there as AF[1-4][1-3], CS[1-7], EF and Default, a total of 22 different traffic classes. In addition, customer feedback has indicated that the complete decode of the ToS byte is required.

TABLE N1
Z Field Encoding - DSCP

| Value | DSCP Offset (bits) | Comments |
|---|---|---|
| 0 | 0 | Programmable |
| 1 | 8 | IPv4 |
| 2 | 4 | IPv6 |
| 3 | 4 or 8 | IPv4 or IPv6 |

The device will interpret the Z nibble for DSCP filtering as shown in Table N1. If the octet at the offset shown in the table does not have the desired value (four for IPv4, six for IPv6) then the frame will either be discarded or assigned to the priority queue assigned by the DSCP IP Version Mismatch Register. This register is described in Table O1.

If Z=3, then the device will accept either value. The DSCP values will be located at the offset appropriate for the IP version actually found in the first nibble of the packet.

TABLE O1
DSCP IP Version Mismatch Register

| Field(s) | Function | Comments |
|---|---|---|
| Enable | A 0 disables this function | |
| Discard | Causes frame to be discarded if | |
| | set to 1 | |
| CoS Type | Determines CoS assignment | Mismatched IP version |
| | method. A two-bit field: | frames enter this CoS |
| | 0 -> Use CoS level C | if not discarded. |
| | 1 -> Reserved | |
| | 2 -> Reserved | |
| | 3 -> Reserved | |
| C | CoS assignment: the direct | |
| | CoS value | |
| IDD6 | The value stored here will be | Used to implement |
| Programmable | used in the ingress forwarding | customer-specific |
| Bit | header IDD6 programmable bit. | functions |
| Timestamp | If 1 then matching frames will | |
| Enable | have timestamp fields updated | |
| | in the forwarding headers. If | |
| | excess latency detect is | |
| | enabled, this may also cause | |
| | the frame to be discarded if the | |
| | queuing latency threshold is | |
| | exceeded. | |
| Timestamp | Selects which timestamp delay | Typically: |
| Select | will be enforced. | Voice ≦ 10 ms, |
| | | video ≦ 100 ms |

Because DSCP reuses the ToS field of the IPv4 header, the device will need to encode bits for which several different uses have been proposed. In order to provide an interface capable of addressing the needs of both the old and new definitions of these bits, the device will have 64 registers, each structured as shown in Table P1. The non-ToS/DSCP related bits (currently assigned to ECN) must be ignored. The remaining 6-bits of the DSCP octet are used to directly index into the DSCP Assignment Registers and determine the CoS and discard eligibility of the frame.

TABLE P1
DSCP Assignment Register (x64)

| Field(s) | Function | Comments |
|---|---|---|
| Enable | A 0 disables this function | |
| Discard | Causes frame to be discarded if | |
| | set to 1 | |
| CoS Type | Determines CoS assignment | |
| | method. A two-bit field: | |
| | 0 -> Use CoS level C | |
| | 1 -> Reserved | |
| | 2 -> Reserved | |
| | 3 -> Reserved | |
| C | CoS assignment: the direct CoS value | |
| Timestamp | If 1 then matching frames will | |
| Enable | have timestamp fields updated in | |
| | the forwarding headers. If excess | |
| | latency detect is enabled, this | |
| | may also cause the frame to be | |
| | discarded if the queuing latency | |
| | threshold is exceeded. | |
| Timestamp | Selects which timestamp delay | Typically: |
| Select | will be enforced. | Voice ≦ 10 ms, |
| | | video ≦ 100 ms |

While the present invention has been described in considerable detail and in connection with the preferred embodiment, it will be understood that it is not so limited. On the contrary, it is intended to cover all alternatives, modifications and equivalents as may be included within the spirit and the scope of the invention as defined in the appended claims and all changes which come within the meaning and range of equivalency of the claims are intended to be included therein.

What is claimed is:

1. A method for transmitting data, said method comprising:
receiving said data from at least one source;
determining priority level of said data from code instructions transmitted with said data;
selectively dropping a portion of said data;
determining available memory resources for the remainder of said data;
selecting the memory resources for recording the remainder of said data; recording the remainder of said data into said memory resources; reading the stored data from said memory resources;
and sending said data out of the memory resources.

2. The method claim 1 wherein said code instructions comprise at least: multi protocol label switching, multi protocol label switching EXP field, inner vLAN, outer vLAN, destination address, source address, multicast destination address, layer 2 Ethertype, link layer control, encoding, sub network access protocol encoding, internet protocol, internet protocol version, differential service code point or layer 3 protocol.

3. The method of claim 1 wherein said data are Ethernet frames received at 10 Megabits per second (Mbps), 100 Mbps, 1 Gigabit per second (Gbps) or 10 Gbps.

4. The method of claim 1 wherein said data are free of said code instructions.

5. The method of claim 1 wherein a portion of said data are dropped by Weighted Random Early Detection (WRED) approach.

6. The method of claim 1 wherein no data are dropped at 1 Gbps transmission rate for interfaces operating at 1 Gbps.

7. The method of claim 1 wherein no data are dropped at 10 Gbps transmission rate for interfaces operating at 10 Gbps.

8. The method of claim 1 wherein said memory resources are partitioned in 1 Kilobyte blocks.

9. The method of claim 1 wherein said memory resources are external to the invention.

10. The method of claim 9 wherein said external memory resources are partitioned in 4 Kilobyte blocks.

11. The method of claim 1 wherein said memory operates at between approximately 100 Megahertz and approximately 200 Megahertz.

12. The method of claim 1 wherein said reading from said memory resources is performed at 155 MHz.

13. The method of claim 1 further partitioning said available memory resources into a free list and an allocation list.

14. The method of claim 5 wherein said data are dropped when exceeding a pre-selected threshold level.

15. The method of claim 13 further comprising updating said free list and said allocation list.

16. The method of claim 1 wherein said reading the stored data further comprises Modified Reduced Deficit Round Robin (MDRR) servicing.

17. A device for transmitting data, said device comprising: at least one physical (PHY) layer located on ingress side of said device; at least one media access control (MAC) device; at least one Reduced Medium-independent Interface (RMII), a Reduced Gigabit medium-Independent Interface (RGMII), a Serial Gigabit Media Independent Interface (SGMII), 10 GigabitAttachment Unit Interface (XAUI) or 10 Gigabit Small Form-factor Pluggable Electrical Interface (XFI); a flow control mechanism, a memory; and a data sending unit.

18. The device of claim 17 wherein said at least one PHY layer is three PHY layers and wherein said at least one MAC is three MACs.

19. The device of claim 17 wherein said at least one PHY layer is an 8 port device.

20. The device of claim 17 wherein said at least one PHY layer is a 24 port device.

21. The device of claim 17 wherein said memory is 256 KB memory.

22. The device of claim 17 wherein said memory is 384 KB memory.

23. The device of claim 17 wherein said memory is 480 KB memory.

24. The device of claim 17 wherein said memory is a dual ported Random Access Memory (RAM).

25. The device of claim 17 wherein said memory is partitioned into 1 KB memory blocks.

25. The device of claim 17 wherein said memory is used to contain allocation information for external memory blocks.

26. The device of claim 25 wherein said external memory is partitioned into 4 KB memory blocks.

27. The device of claim 17 further comprising a System Packet Interface Level 4 Phase 2 (SPI 4.2) device.

28. The device of claim 17 further comprising a XAUI interface as the system-side interface.

30. Device for transmitting data, said device comprising: means for receiving said data; means for prioritizing said data; means for selectively dropping some of said data; means for writing said data into a memory; means for reading said written data from said memory; and means for sending said written data from said memory.
